(19) United States
(12) Patent Application Publication
(10) Pub. No.: US 2026/0166772 A1
(43) Pub. Date: Jun. 18, 2026

(54) WEB SUPERPOSING DEVICE AND BAG MAKING APPARATUS

(71) Applicant: Totani Corporation, Kyoto (JP)

(72) Inventor: Yuji OHNISHI, Kyoto (JP)

(73) Assignee: Totani Corporation, Kyoto (JP)

(21) Appl. No.: 19/128,519

(22) PCT Filed: May 12, 2023
(86) PCT No.: PCT/JP2023/043457

§ 371 Date: May 8, 2025

(30) Foreign Application Priority Data
Jan. 18, 2023 (JP) 2023-005888

(51) Int. Cl. B26D 9/00; B31B 70/26; B31B 70/81; B31B 155/00; B65D 33/06

(52) U.S. Cl. CPC B26D 9/00; B31B 70/262; B31B 70/8132; B65D 33/065; B31B 2155/001; B31B 2155/002

(57) ABSTRACT

A web superposing device slits a first main web with a first slitter into a first outer panel web and a second outer panel web. The superposing device slits a second main web with the second slitter into a first inner panel web and a second inner panel web. The superposing device guides the first and second outer panel webs to a superposing roller pair. The superposing device separates the first and second outer panel webs from each other until the first and second outer panel webs reach the superposing roller pair to form a space between the first and second outer panel webs. The superposing device guides the first and second inner panel webs via the space to the superposing roller pair to superpose these four webs on each other at the superposing roller pair.

### CROSS-REFERENCE TO RELATED APPLICATIONS

This application is a 371 application of international PCT application serial no. PCT/JP2023/043457, filed on Dec. 5, 2023, which claims the priority benefit of Japan application JP2023-005888, filed on Jan. 18, 2023. The entirety of the above-mentioned patent applications are hereby incorporated by reference herein and made a part of this specification.

### TECHNICAL FIELD

The present application relates to a web superposing device for use in a bag making apparatus for successively making double bags. The present application also relates to a bag making apparatus for successively making double bags.

### BACKGROUND

Double bags are well-known, for example, as disclosed in Patent Documents 1 and 2. A double bag includes at least two composite sheets facing each other. A storage space is formed by the two composite sheets between them. Each composite sheet is constituted by an inner panel and an outer panel superposed on each other. Thus, the double bag is constituted by two inner panels and two outer panels, i.e., at least four sheets.

Patent document 1 also discloses a bag making apparatus that successively makes the double bags. Such a bag making apparatus feeds webs from four rolls installed at the most upstream section of the apparatus. Two rolls are used for the outer panels, and the remaining two rolls are used for the inner panels. A web superposing device including guide rollers, a superposing roller pair, and so on is arranged in the bag making apparatus to superpose the four webs, which have been fed from the rolls, respectively, on each other. The superposed webs are then fed to processing devices such as a heat sealer, and processed.

Making double bags requires four rolls as disclosed in Patent document 1. Slight differences in the feed speeds and roll quantities of the four rolls may cause slight deviations in the time at which the four rolls run out. Accumulation of these differences cause the deviation in the time to replace a roll, resulting in increased labor for the replacement of the rolls.

### SUMMARY

According to the present application, there is provided a web superposing device for use in a bag making apparatus configured to successively make double bags. The double bags each having a first outer panel, a second outer panel, a first inner panel, and a second inner panel. The first and second inner panels face each other and are interposed between the first and second outer panels.

The web superposing device includes: a first slitter for slitting a first main web into a first outer panel web for the first outer panel and a second outer panel web for the second outer panel as the first main web is fed from a first roll; a second slitter for slitting a second main web into a first inner panel web for the first inner panel and a second inner panel web for the second inner panel as the second main web is fed from a second roll; a superposing roller pair; a first guide mechanism for guiding the first main web through the first slitter and guiding the first and second outer panel webs to the superposing roller pair, wherein the first guide mechanism is configured to keep the first and second outer panel webs separated from each other until the first and second outer panel webs reach the superposing roller pair to form a space between the first and second outer panel webs; and a second guide mechanism for guiding the second main web through the second slitter and guiding the first and second inner panel webs from the space to the superposing roller pair to superpose the first outer panel web, the second outer panel web, the first inner panel web, and the second inner panel web on each other at the superposing roller pair.

The superposing roller pair may be spaced away from the first and second rolls in a forward horizontal direction.

The first guide mechanism may include: a first separation guide for redirecting the first outer panel web from a lateral direction to an upward direction and the second outer panel web from the lateral direction to a downward direction, the lateral direction being perpendicular to the forward horizontal direction; a first downstream horizontal roller disposed downstream of the first separation guide to redirect the first outer panel web from the upward direction to the forward horizontal direction; and a second downstream horizontal roller disposed downstream of the first separation guide to redirect the second outer panel web from the downward direction to the forward horizontal direction.

The second guide mechanism may include: a second separation guide for redirecting the first inner panel web from the lateral direction to the upward direction and the second inner panel web from the lateral direction to the downward direction; a third downstream horizontal roller disposed downstream of the second separation guide to redirect the first inner panel web from the upward direction to the forward horizontal direction; and a fourth downstream horizontal roller disposed downstream of the second separation guide to redirect the second inner panel web from the downward direction to the forward horizontal direction.

The second slitter and the second separation guide may be spaced from the first separation guide in the forward horizontal direction and located below the first downstream horizontal roller and above the second downstream horizontal roller.

The third and fourth downstream horizontal rollers may be spaced from the first separation guide in the forward horizontal direction and are located below the first downstream horizontal roller and above the second downstream horizontal roller.

The second guide mechanism may further include detour rollers for detouring the second main web in the lateral direction from the first slitter and the first separation guide.

The first guide mechanism may further include a first downstream vertical roller for redirecting the first main web from the forward horizontal direction to the lateral direction to pass the first main web through the first slitter. The first slitter may be arranged to slit the first main web while the first main web is fed in the lateral direction subsequent to passing through the first downstream vertical roller.

The second guide mechanism may further include a second downstream vertical roller for redirecting the second main web from the forward horizontal direction to the lateral direction to pass the second main web through the second slitter. The second slitter may be arranged to slit the second main web while the second main is fed in the lateral direction subsequent to passing through the second downstream vertical roller.

The first and second guide mechanisms are configured to guide the first and second outer panel webs and the first and second inner panel webs to orient edges of the first and second outer panel webs and the first and second inner webs in a same direction, said edges resulting from slitting.

According to the present application, a bag making apparatus for successively making double bags is also provided. The bag making apparatus includes the web superposing device described above.

The bag making apparatus may further include: a feeder disposed downstream of the superposing roller pair to intermittently feed the first and second outer panel webs and the first and second inner panel webs; a first dancer roller for engaging with the first outer panel web at a position upstream of the superposing roller pair to switch the first outer panel web from continuous feed to intermittent feed; a second dancer roller for engaging with the second outer panel web at a position upstream of the superposing roller pair to switch the second outer panel web from continuous feed to intermittent feed; a first mechanical linkage for interlocking the first and second dancer rollers with each other; and a first biasing member for applying the first and second dancer rollers towards the first and second outer panel webs, respectively, via the first mechanical linkage.

The bag making apparatus may further include: a third dancer roller for engaging with the first inner panel web at a position upstream of the superposing roller pair to switch the first inner panel web from continuous feed to intermittent feed; a fourth dancer roller for engaging with the second inner panel web at a position upstream of the superposing roller pair to switch the second inner panel web from continuous feed to intermittent feed; a second mechanical linkage for interlocking the third and fourth dancer rollers with each other; and a second biasing member for applying the third and fourth dancer rollers towards the first and second inner panel webs, respectively, via the second mechanical linkage.

The bag making apparatus may further include: a feeder disposed downstream of the superposing roller pair to intermittently feed the first and second outer panel webs and the first and second inner panel webs; a sealer disposed downstream of the superposing roller pair to heat-seal the first and second outer panel webs and the first and second inner panel webs; and a cross cutter disposed downstream of the sealer to cross-cut the first and second outer panel webs and the first and second inner panel webs in a width direction of thereof during every intermittent feed cycle to make the double bags.

### BRIEF DESCRIPTION OF THE DRAWINGS

FIG. 1A illustrates an example double bag, and FIG. 1B is a partial cross-sectional view of the bag of FIG. 1A.

FIG. 2A is a schematic plan view of an upstream section of an example bag making apparatus, and FIG. 2B is a side view thereof.

FIG. 3 is a schematic side view of a downstream section of the bag making apparatus of FIG. 2A.

FIGS. 4A and 4B illustrate an example accumulator.

FIG. 5 is a schematic side view of an example superposing device.

FIG. 6 illustrates views taken along the lines A-A, B-B, C-C, and D-D of FIG. 5.

FIG. 7 is a plan view of FIG. 5.

FIG. 8A illustrates a configuration for positional adjustment of a first main web, FIG. 8B is an enlarged view of an area T in FIG. 8A, FIG. 8C illustrates an inclined plate, FIG. 8D illustrates a S-S enlarged section of FIG. 8C, and FIG. 8E illustrates a configuration for positional adjustment of a second main web.

FIG. 9A illustrates another configuration for positional adjustment, and FIG. 9B is an enlarged view of an area T in FIG. 9A.

FIG. 10 illustrates a configuration for interlocking dancer rollers.

FIG. 11 illustrates a configuration for reducing swing amplitudes of arms of a mechanical linkage.

FIG. 12A is a schematic plan view of a further example superposing device, and FIG. 12B is a side view thereof.

FIG. 13 illustrates views taken along the lines A-A, B-B, C-C, and D-D of FIG. 12B.

FIG. 14A is a schematic plan view of a further example superposing device, and FIG. 14B is a side view thereof.

FIG. 15 illustrates views taken along the lines A-A, B-B, C-C, and D-D of FIG. 14B.

FIG. 16A is a schematic plan view of a further example superposing device, and FIG. 16b is a side view thereof.

FIG. 17 illustrates views taken along the lines A-A, B-B, C-C, and D-D of FIG. 16B.

### DETAILED DESCRIPTION

Embodiments according to the present application will now be described below with reference to the accompanying drawings. The followings are merely illustrations of the present inventions. It should be understood that the Figures are merely schematic and are not drawn to scale. It should also be understood that the same reference numerals are used throughout the Figures to indicate the same or similar components.

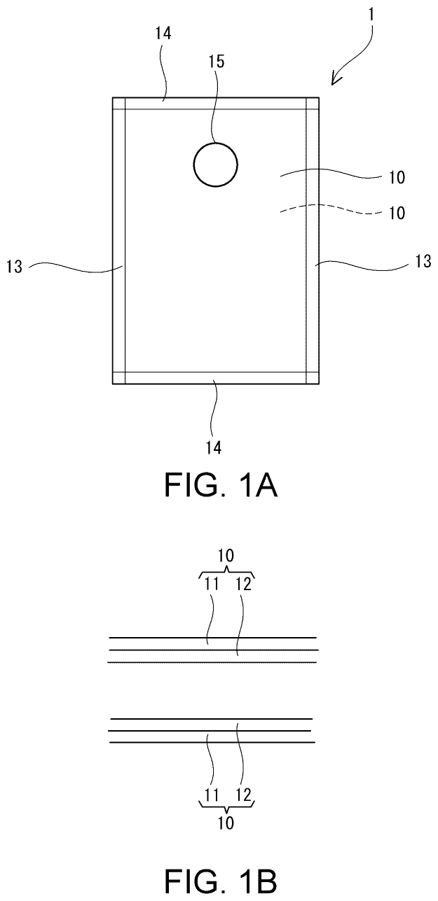

FIG. 1A illustrates an example bag 1. The bag 1 includes composite sheets 10 facing each other. As illustrated in FIG. 1B, which is a partial cross-sectional view, each composite sheet 10 includes an outer panel 11 and an inner panel 12 that are superposed on each other. The bag 1 includes a first sealed sections 13 formed along the opposite side edges of the bag 1 and a second sealed sections 14 formed along the top and bottom edges of the bag 1. The bag 1 further includes a spout 15 attached to one of the composite sheets 10. Through the spout 15, contents can be filled into or taken out of the storage space formed between the two composite sheets 10.

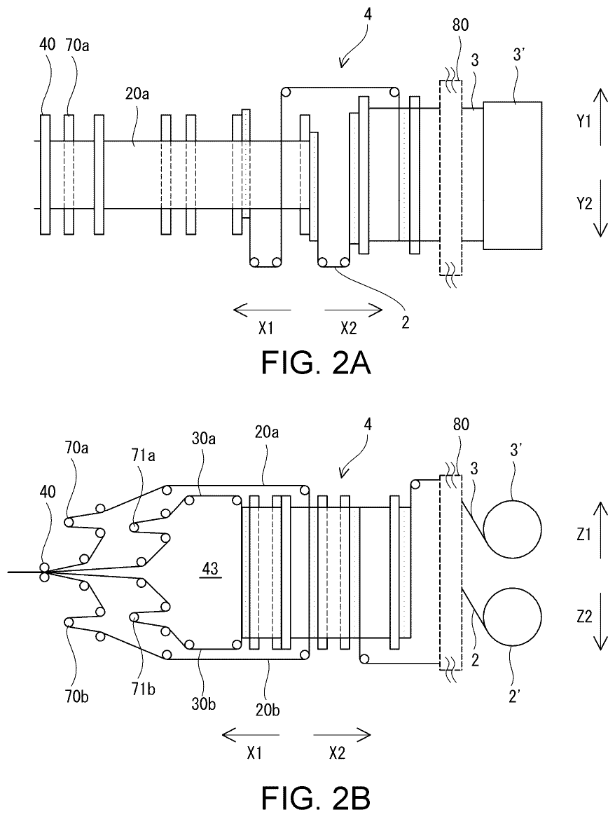

FIGS. 2A and 2B schematically illustrate an upstream section of an example bag making apparatus for successively making the bags 1 of FIG. 1. Two rolls 2′ and 3′ are arranged. One roll 2′ is constituted by a first main web 2 for the above-described outer panels 11 being wound. The other roll 3′ is constituted by a second main web 3 for the above-described inner panels 12 being wound. In this example, the roll 2′ is arranged on the lower side and the roll 3′ is arranged on the upper side. The direction X1 is the forward horizontal direction of the webs and the direction X2 is the opposite direction to X1. The directions Y1 and Y2 are horizontal and lateral directions perpendicular to the direction X1. Y1 is the first lateral direction and Y2 is the second lateral direction. Z1 is the upward direction and Z2 is the downward direction.

The web 2 has, for example, a laminated structure. One surface layer (base layer) of the web 2 has a higher melting point than that of the other surface layer (sealant layer). The web 3 may be made of a material having a lower melting point than that of the base layer of the web 2. Other characteristics (e.g., thickness) of the webs 2 and 3 are determined according to the characteristics (e.g., bag strength) of the bags 1 to be made. This is the same as in Reference 1.

The webs 2′ and 3′ are unwound from the rolls 2′ and 3′, respectively, and are continuously fed in the longitudinal direction thereof at a predetermined speed to pass through an accumulator 80.

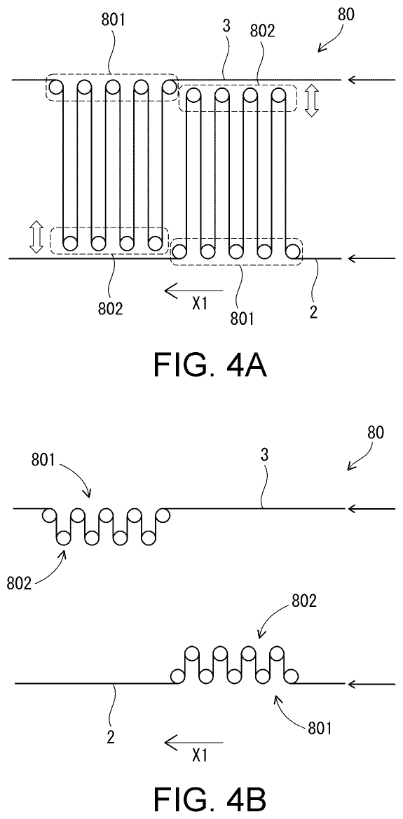

The accumulator 80 functions to temporarily store the webs 2 and 3 for some length. In the example accumulator 80 in FIG. 4A, a group 801 of stationary rollers and a group 802 of movable rollers are provided for each of the webs 2 and 3. Each of the webs 2 and 3 are alternately engaged with the stationary and movable rollers, respectively. As illustrated in FIGS. 4A and 4B, the accumulator 80 moves the group 802 of movable rollers towards and away from the group 801 of stationary rollers using an actuator (not illustrated) for adjusting the storage amount. FIG. 4A illustrates it with the higher storage amount. FIG. 4B illustrate it with the lower storage amount.

When the roll amount of the roll becomes small, an operator replaces the roll with a new one. In replacing the roll with new one, the web fails to be fed to the accumulator 80. During this time, the accumulator 80 feeds the stored web downstream. The operator completes the replacement of the roll before the storage amount reaches zero. Then, the accumulator 80 increases the speed of unwinding a web from the new roll while increasing the storage amount. This allows a web to be continuously fed to the respective devices located downstream even during the replacement of a roll, enabling the bag making processes to continue.

The bag making apparatus further includes a web superposing device 4, as illustrated in FIG. 2B. The superposing device 4 slits the first main web 2 (unwound from the first roll 2′) in the longitudinal direction thereof into two outer panel webs 20a and 20b, and also slits the web 3 (unwound from the second roll 3′) in the longitudinal direction thereof into two inner panel webs 30a and 30b. This configuration will be described in detail later.

The bag making apparatus further includes dancer rollers 70a to 71b provided for the respective four webs 20a to 30b, and switches the webs 20a and 20b/30a and 30b from continuous feed to intermittent feed using the dancer rollers 70a and 70b/71a and 71b. Thus, the webs 20a to 30b repeat to be fed and paused in the area downstream of the dancer rollers 70a, 70b, 71a and 71b.

The superposing device 4 includes a superposing roller pair 40 located to be spaced from the rolls 2′ and 3′ in the forward horizontal direction X1. The superposing device 4 guides the four webs 20a to 30b via the dancer rollers 70a to 71b to the superposing roller pair 40 and passes them through the superposing roller pair 40. At this time, the superposing device 4 superposes the four webs 20a to 30b on each other at the superposing roller pair 40. The order of superposing is, from top to bottom, the outer panel web 20a, the inner panel web 30a, the inner panel web 30b, and the outer panel web 20b. Here, the higher melting point surface layer (base layer) of the outer panel web 20a is oriented in the upward direction Z1. The lower melting point surface layer (sealant layer) of the web 20a is oriented in the downward direction Z2 and contacts the inner panel web 30a. The higher melting point surface layer of the outer panel web 20b is oriented in the downward direction Z2. The lower melting point surface layer of the web 20b is oriented in the upward direction Z1 and contacts the inner web 30b. The configuration for this will also be described in detail later.

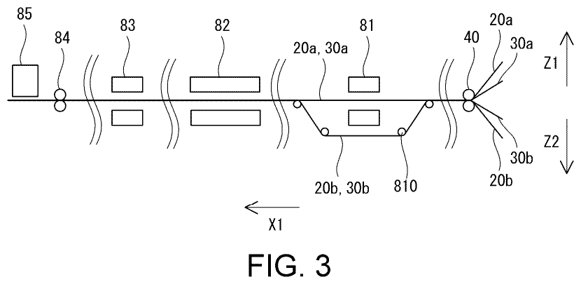

FIG. 3 schematically illustrates a downstream section of the bag making apparatus of FIGS. 2A and 2B. The bag making apparatus further includes at least one feeder 84 disposed downstream of the superposing roller pair 40. The feeder 84 includes, for example, a drive roller pair and a servo motor. The drive roller pair being intermittently rotated by the servomotor causes the webs 20a to 30b sandwiched by the drive roller pair to be intermittently fed. The feed direction is designated by X1.

The bag making apparatus further includes a spout attachment device 81 disposed downstream of the superposing roller pair 40. The spout attaching device 81 includes guide rollers 810 that temporarily separate the four superposed webs 20a to 30b into two webs 20a and 30a (which will become one composite sheet 10) and two webs 20b and 30b (which will become the other composite sheet 10). The spout attaching device 81 attaches a spout 15 to the webs 20a and 30a in this separation zone during every intermittent feed cycle. The spout attaching device 81 includes, for this purpose, a puncher unit that punches a hole in the webs 20a and 30a, and a sealer unit that inserts the spout 15 through said hole and seals it to the webs 20a and 30a. For example, such puncher unit and sealer unit may have the same configurations as those disclosed in Patent Document 1.

The bag making apparatus further includes at least one heat sealer 82, 83 disposed downstream of the superposing roller pair 40. The heat sealers 82 and 83 each heat-seal the webs 20a to 30b using heat seal bars during every intermittent feed cycle. As mentioned above, the lower melting surface layers of the webs 20a and 20b contact the inner panel webs 30a and 30b having lower melting point, respectively. Therefore, the inner panel webs 30a and 30b are heat-sealed to each other and to the outer panel webs 20a and 20b, respectively. Thereby, the sealed sections 13 and 14 of the bags 1 are formed.

The bag making apparatus further includes a cross cutter 85 disposed downstream of the heat sealers 82 and 83. The cross cutter 85 cross-cuts the four webs 20a to 30b in the width direction of thereof using a blade during every intermittent feed cycle. A bag 1 is formed every cross-cutting. Two outer panels 11 are formed from the portions cut off from the outer panel webs 20a and 20b by the cross-cutting. Two inner panel parts 12 are formed from the portions cut off from the inner panel webs 30a and 30b by the cross-cutting. In this manner, the double bags 1 are successively made.

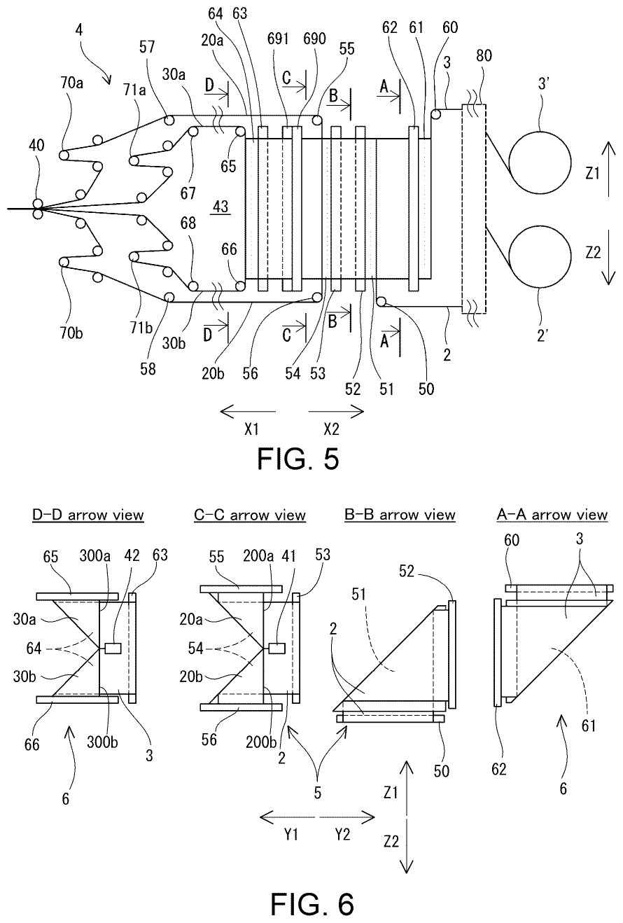

The example superposing device 4 is described below with reference to FIGS. 5, 6, and 7. FIG. 6 collectively illustrates view taken along the lines A-A, B-B, C-C, and D-D of FIG. 5.

The main web 2 for the outer panels is unwound from the roll 2′ through the accumulator 80 to be fed in the forward horizontal direction X1 from the lower part of the accumulator 80. The main web 3 is unwound from the roll 3′ through the accumulator 80 to be fed in the forward horizontal direction X1 from the upper part of the accumulator 80. In this example, the roll 2′ for the outer panels is made by a web 2 being wound such that the higher melting point surface layer (base layer) is oriented outward.

A configuration relating to the web 2 is illustrated in the B-B and C-C arrow views in FIG. 6 (where the webs 3, 30a and 30b are not illustrated). The superposing device 4 includes a first slitter 41 for slitting the web 2 into the two outer panel webs 20a and 20b described above while the web 2 is being fed in the longitudinal direction thereof. The superposing device 4 further includes a first guide mechanism 5 that guides the web 2 through the slitter 41 and guides the resulting webs 20a and 20b to the superposing roller pair 40.

The first guide mechanism 5 includes a first upstream horizontal roller 50, a first inclined plate 51, a first upstream vertical roller 52, a first downstream vertical roller 53, a first separation guide 54, and first and second downstream horizontal rollers 55 and 56.

The web 2 is redirected by the upstream horizontal roller 50 from the forward horizontal direction X1 to the upward direction Z1, then redirected by the triangular-shaped inclined plate 51 to the second horizontal direction Y2, and then redirected by the upstream vertical roller 52 to the forward horizontal direction X1 again. In other words, in the B-B arrow view in FIG. 6, the first guide mechanism 5 converts, using these components 50 to 52, the surface of the web 2 (being fed in the forward horizontal direction X1) from horizontal to vertical.

The web 2 is then fed to the downstream vertical roller 53. The higher melting point surface layer of the web 2 is oriented in the second lateral direction Y2 in the section between the rollers 52 and 53.

The web 2 passes through the downstream vertical roller 53 and is then redirected from the forward horizontal direction X1 to the first lateral direction Y1 to pass through the slitter 41. In this process, the web 2 is slit by the slitter 41 in the longitudinal direction thereof at the center position thereof into the outer panel webs 20a and 20b. The webs 20a and 20b are fed to the separation guide 54.

The separation guide 54 is an M-shaped guide plate consisting of two triangular inclined plates joined together. The outer panel web 20a is redirected by the separation guide 54 from the first lateral direction Y1 to the upward direction ZI to be fed to the downstream horizontal roller 55. Meanwhile, the outer panel web 20b is redirected by the separation guide 54 from the first lateral direction Y1 to the downward direction Z2 to be fed to the downstream horizontal roller 56. The downstream horizontal roller 55 then redirects the upper web 20a to the forward horizontal direction X1 while converting the surface thereof from vertical to horizontal. The downstream horizontal roller 56 redirects the lower web 20b to the forward horizontal direction X1 while converting the surface thereof from vertical to horizontal.

Thus, the first guide mechanism 5 guides the web 2 through the slitter 41 to separate the two resulting webs 20a and 20b from each other vertically and to make the surfaces of the webs 20a and 20b horizontal. When the upper web 20a passes through the downstream horizontal roller 55, its higher melting point surface layer is oriented in the upward direction Z1. When the lower web 20b passes through the downstream horizontal roller 56, its higher melting point surface layer is oriented in the downward direction Z2.

The first guide mechanism 5 further includes guide rollers 57 and guide rollers 58. An appropriate number of guide rollers 57/58 are located between the downstream horizontal roller 55/56 and the superposing roller pair 40 to guide the web 20a/20b via the dancer roller 70a/70b to the superposing roller pair 40. Here, the first guide mechanism 5 keeps the webs 20a and 20b separated from each other using these rollers 55 to 58 until the webs 20a and 20b reach the superposing roller pair 40 to form a space 43 (FIG. 5) between the webs 20a and 20b. This space 43 is utilized to form the inner panel webs 30a and 30b and guide them to the superposing roller pair 40.

The configuration relating to the web 3 is illustrated in the A-A and D-D arrow views in FIG. 6 (where the webs 2, 20a and 20b are not illustrated). The superposing device 4 further includes a second slitter 42 for slitting the web 3 into the two inner panel webs 30a and 30b described above while the web 3 is being fed in the longitudinal direction thereof. The superposing device 4 further includes a second guide mechanism 6 that guides the web 3 through the slitter 42 and guides the resulting webs 30a and 30b from the space 43 to the superposing roller pair 40.

The second guide mechanism 6 includes a second upstream horizontal roller 60, a second inclined plate 61, a second upstream vertical roller 62, a second downstream vertical roller 63, a second separation guide 64, third and fourth downstream horizontal rollers 65 and 66, and midstream vertical rollers 690 and 691.

The web 3 is redirected by the upstream horizontal roller 60 from the forward horizontal direction X1 to the downward direction Z2, then redirected by the triangular-shaped inclined plate 61 to the first lateral direction Y1, and then redirected to the forward horizontal direction X1 again. In other words, in the A-A arrow view in FIG. 6, the second guide mechanism 6 converts the surface of the web 3 (being fed in the forward horizontal direction X1) from horizontal to vertical using these components 60 to 62.

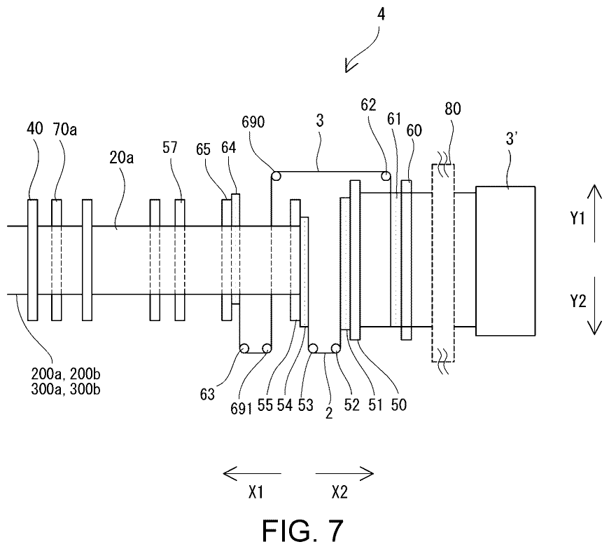

As illustrated in FIG. 7, the web 3 is then fed to the midstream vertical roller 690, redirected by this roller 690 to the second horizontal direction Y2, shifted across a space between the two webs 20a and 20b to the Y2 side, and redirected by the other midstream vertical roller 691 to the forward horizontal direction X1. The web 3 is then fed to the downstream vertical roller 63 with the surface thereof kept vertical. As illustrated in FIG. 7, the web 3 is detoured by the rollers 62 and 690 in the first horizontal direction Y1 from the first slitter 41 and the components 50 to 56 of the first guide mechanism 5. In other words, the rollers 62 and 690 of the second guide mechanism 6 serve as detour rollers.

The web 3 is then redirected by the downstream vertical roller 63 from the forward horizontal direction X1 to the first lateral direction Y1 to pass through the slitter 42. In this process, the web 3 is slit by the slitter 42 in the longitudinal direction thereof at the center position thereof into the inner panel webs 30a and 30b. The webs 30a and 30b are fed to the separation guide 64.

The separation guide 64 is an M-shaped guide plate similar to the separation guide 54. The inner panel web 30a is redirected by the separation guide 64 from the first lateral direction Y1 to the upward direction Z1 to be fed to the downstream horizontal roller 65. Meanwhile, the inner panel web 30b is redirected by the separation guide 64 from the first lateral direction Y1 to the downward direction Z2 to be fed to the downstream horizontal roller 66. The downstream horizontal roller 65 then redirects the upper web 30a to the forward horizontal direction X1, while converting the surface thereof from vertical to horizontal. The downstream horizontal roller 66 redirects the lower web 30b to the forward horizontal direction X1, while converting the surface thereof from vertical to horizontal.

Thus, the second guide mechanism 6 guides the web 3 through the slitter 42 to separate the two resulting webs 30a and 30b vertically from each other and to make the surfaces of the webs 30a and 30b horizontal.

Furthermore, the second guide mechanism 6 further includes guide rollers 67 and guide rollers 68. An appropriate number of guide rollers 67/68 are located between the downstream horizontal roller 65/66 and the superposing roller pair 40 to guide the web 30a/30b via the dancer roller 71a/71b to the superposing roller pair 40.

Thus, the webs 20a to 30b are superposed on each other at the superposing roller pair 40. The order thereof is, from top to bottom, the first outer panel web 20a, the first inner panel web 30a, the second inner panel web 30b, and the second outer panel web 20b. The lower melting point surface layer of the outer panel web 20a contacts the inner panel web 30a, and the lower melting point surface layer of the outer panel web 20b contacts the inner panel web 30b.

The second slitter 42, the second separation guide 64, the third and fourth downstream horizontal rollers 65 and 66, and the guide rollers 67 and 68 are located in said space 43 formed by the first guide mechanism 5. In other words, these components 42, 64 to 68 are spaced from the first separation guide 54 in the forward horizontal direction X1 and located below the first downstream horizontal roller 55 and above the second downstream horizontal roller 56. Thus, arranging the second slitter 42 and the components 64 to 68 of the second guide mechanism 6 in the space 43 formed by the first guide mechanism 5 enables the four webs 20a to 30b (which are formed from the two rolls 2′ and 3′) to be superposed on each other.

As described above, the superposing device 4 slits the webs 2 and 3 unwound from the two rolls 2′ and 3′ into the four webs 20a to 30b, and superposes these webs 20a to 30b on each other at the superposing roller pair 40. Therefore, the bag making apparatus with this superposing device 4 is capable of processing (e.g., heat-sealing) and cross-cutting the four superposed webs 20a to 30b at a position downstream of the superposing roller pair 40, thereby enabling making the double bags 1 successively.

Conventional bag making of double bags requires four rolls in total, two of which are used for the outer panels, the remaining two of which are used for the inner panels. On the other hand, bag making of double bags according to the present application requires only two rolls, one of which 2′ is used for the outer panels, and the other one of which 3′ is used for the inner panels, due to the above-mentioned superposing device 4. This reduces the operator's workload in replacing the rolls, leading to more efficient operation. In addition, the reduction in the number of rolls from four to two reduces the space required for the installation of rolls, which can contribute to the downsizing of the bag making apparatus as a whole.

The above bag making process requires to bring the lower melting point surface layers of the webs 20a/20b into contact with the webs 30a/30b at the superposing roller pair 40 for the heat sealing process. Therefore, it should be noted that when the webs 2, 20a and 20b are redirected by the components of the first guide mechanism 5, this also involves a change in orientation of the higher/lower melting point surface layer of the webs 2, 20a and 20b. Furthermore, it also should be noted whether the first roll 2′ is constituted by the first main web 2 being wound with the higher melting point surface layer of the web 2 oriented outward or inward.

Unlike the above example, if the webs 2 and 3 are made of mono-material instead of laminated structure, a medium ink that inhibits heat-sealing may be applied to one surface thereof. Thus, back and front surfaces are generally defined for the webs 2 and 3.

Therefore, although the guiding mechanisms 5 and 6 may have additional components or a different configuration than the above examples, in performing bag making which involves heat-sealing, the conversion in the surfaces of the webs by the components of the guiding mechanisms 5 and 6 and the front and back of the webs should be given due attention. This can be easily understood by those skilled in the art.

The example main web 2 (outer panel webs 20a and 20b) has a base layer and a sealant layer. The base layer is generally more resistant to scratches and friction than the sealant layer. Therefore, when the webs 2, 20a or 20b is guided by the components of the first guide mechanism 5, such as the first inclined plate 51 and the first separation guide 54, generating frictional force, it is preferable to have the base layer in frictional contact with these components instead of the sealant layer.

As illustrated in the C-C and D-D arrow views in FIG. 6, the slitting results in edges 200a, 200b, 300a and 300b in the webs 20a to 30b, respectively. As illustrated in FIG. 7, the first and second guide mechanisms 5 and 6 ensure that all of the edges 200a, 200b, 300a and 300b are oriented in the same direction (second lateral direction Y2 in the embodiment) at the superposing roller pair 40. Furthermore, as illustrated in FIG. 7, the first and second guide mechanisms 5 and 6 align these edges 200a to 300b with each other when the webs 20a to 30b are superposed on each other at the superposing roller pair 40.

The straightness of the edges on the opposite sides of the main web 2 and 3 is low due to the manufacturing and feeding processes of the main web itself. On the other hand, as in the embodiment, the edges 200a to 300b of the webs formed by slitting while being fed by the device are highly straight, and the position through which the edges are passing is stable. Therefore, accurate alignment of the edges 200a to 300b leads to the improved accuracy of bag making (a necessary process for bag making).

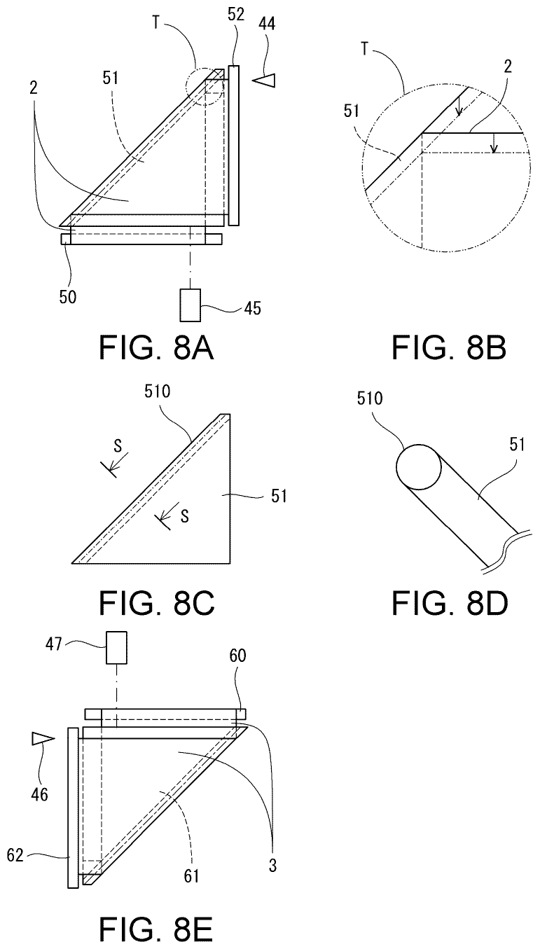

An example configuration for this purpose is described below. As illustrated in FIG. 8A, the superposing device 4 may include a first position sensor 44 for detecting the position of the web 2 in the width direction during feed, and an actuator 45 for fine vertical adjustment of the inclined plate 51.

As illustrated in FIG. 8C, the inclined plate 51 has an inclined edge 510 for redirecting the web 2. The web 2 is turned back by means of the engagement with the inclined edge 510 to be redirected involving a reversal of the orientation of the surfaces thereof. The inclined edge 510 is rounded to prevent damage to the web 2, as illustrated in the S-S section of FIG. 8D. The inclined plate 61 and the separation guides 54 and 64 (M-shaped guide plates) also have similar inclined edges, thereby enabling smooth directional change of the webs with a reversal of the surface orientation.

In this example, the position sensor 44 detects the height of the edge of the web 2 at the first upstream vertical roller 52 for the main web 2 (where the edge of the web 2 extends horizontally). Alternatively, the position sensor 44 may detect the position of the web 2 in the width direction by detecting a line mark (printed or provided by other means) on the web 2. The position sensor 44 is an optical sensor. The actuator 45 slightly moves the inclined plate 51 vertically.

As is clear from FIG. 8B, as the inclined plate 51 descends, the web 2 after passing through the inclined edge 510 of the inclined plate 51 also descends (see arrows in FIG. 8B). At this time, the height of the edge (line mark) detected by the position sensor 44 also descends. Similarly, when the inclined plate 51 rises, the web 2 also rises and the height of the detected edge also rises. Thus, the superposing device 4 can fine-adjust the web 2 in the width direction (the height of the web 2) by finely moving the inclined plate 51 vertically using the actuator 45.

Downstream of that, the web 2 is slit by the slitter 41 into two webs 20a and 20b, as described above. Here, the slitter 41 is stationary. This means that the superposing device 4 (one or more processors thereof) can fine-adjust the positions of the edges 200a and 200b (which result from the slitting) by fine-adjusting the inclined plate 51 vertically via the actuator 45 based on the detection by the position sensor 44.

As illustrated in FIG. 8E, the superposing device 4 may also include a position sensor 46 and the actuator 47 for the main web 3 to fine-adjust the position of the edges 300a and 300b of the webs 30a and 30b in a similar manner.

In this example, the main webs 2 and 3 are slit by the slitters 41 and 42, respectively, after fine adjustment of the edges, so that the edges that will be located on the Y1 side are detected by the position sensors 44 and 46. Therefore, the edges detected by the position sensors 44 and 46 can be aligned with each other with high accuracy on the Y1 side after the slitting.

Furthermore, as described above, one edge of the main web 2/3 is detected by position sensor 44/46 and its position is fine-adjusted by the actuator 45/47 based on the detection by the position sensor 44/46. Then, the main webs 2/3 is slit by slitter 41/42 which is mechanically fixed in position. Therefore, after slitting, the edges 200a to 300b resulting from the slitting can also be aligned with high accuracy on the Y2 side.

Therefore, the superposing device 4 is capable of aligning the edges of the webs 20a to 30b with each other with high accuracy due to this configuration. As a result, highly accurate bag making is enabled.

The Y1 side edges of the webs 20a to 30b, although fine-adjusted, can be somewhat uneven due to variations in the full width dimensions of the original main webs 2 to 3. Such a problem may be solved by slitting the web 20a to 30b along the Y1 side edges in a subsequent process. If the fine-adjusted edges 200a to 300b on the Y2 side can subsequently be misaligned, this may be adjusted by known means if necessary.

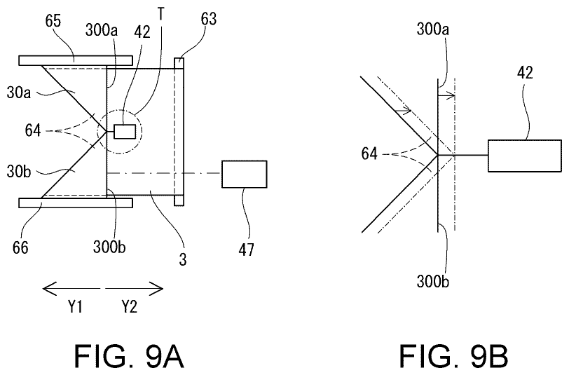

As illustrated in FIGS. 9A and 9B, the positions of the edges 300a and 300b may be adjusted by the movement of the separation guide 64, which is a M-shaped guide plate, in the width directions Y1 and Y2 with the actuator 47 (see arrows in FIG. 9B, for example). Furthermore, although not illustrated in Figures, the positions of the edges 200a and 200b may be adjusted by the movement of the separation guide 54 (the C-C arrow view in FIG. 6) in the lateral directions Y1 and Y2 with the actuator 45.

As described above, the bag making apparatus includes a first dancer roller 70a for engaging with the first outer panel web 20a, a second dancer roller 70b for engaging with the second outer panel web 20b, a third dancer roller 71a for engaging with the first inner panel web 30a, a fourth dancer roller 71b for engaging with the second inner panel web 30b. The bag making apparatus switches these webs 20a to 30b from continuous feed to intermittent feed using these rollers 70a to 71b.

In addition, the bag making apparatus includes a first mechanical linkage 90 for interlocking the first and second dancer rollers 70a and 70b with each other, and a first biasing member 94 (e.g., cylinder) for biasing the first and second dancer rollers 70a and 70b towards the webs 20a and 20b, respectively.

The first mechanical linkage 90 includes two arms 91a and 91b that are substantially L-shaped, have the same shape as each other, and each include a short portion and a long portion. The arms 91a/91b is pivotable around at the elbow thereof via a pivot shaft 92a/92b. The dancer roller 70a is rotatably supported at the end of the long portion of the arm 91a, and the dancer roller 70b is rotatably supported at the end of the long portion of the arm 91b. The ends of the short portions of the two arms 91a and 91b are connected to each other via a link 93. This configuration of the first mechanical linkage 90 enable the dancer rollers 70a and 70b to move together at the same distance and in the same direction.

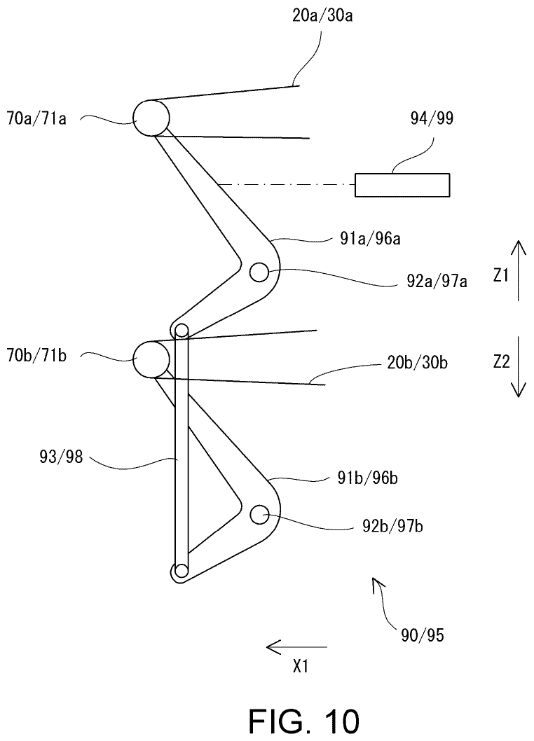

In addition, the first biasing member 94 biases the arms 91a and 91b towards the first and second outer panel webs 20a and 20b (counterclockwise in FIG. 10) to apply tension to the first and second outer panel webs 20a and 20b.

For example, even if the upper outer panel web 20a engaged with the dancer roller 70a slacks, the two arms 91a and 91b (and thus the dancer rollers 70a and 70b) rotate (counterclockwise in FIG. 10) in conjunction with the first biasing member 94, thereby forcibly stretching the lower outer panel web 20b and eliminating the slack of the outer panel web 20a. As a result, the path line length for the outer panel web 20a and the path line length for the outer panel web 20b become the same as each other.

The webs 20a and 20b are formed by slitting one main web 2, and thus, their lengths are theoretically the same. However, both of the pass line lengths practically can vary during feed due to the uneven thickness of the main web 2 over the width direction thereof, etc. The mechanical linkage 90 and the biasing member 94 described above can solve this problem, since they keep both of the pass line lengths same as each other.

The bag making apparatus includes a second mechanical linkage 95 for interlocking the third and fourth dancer rollers 71a and 71b, and a second biasing member 99 (e.g., a cylinder) for biasing the third and fourth dancer rollers 71a and 71b towards the web 30a and 30b, respectively, via the second mechanical linkage 95. The second mechanical linkage 95 includes arms 96a and 96b, pivot shafts 97a and 97b, and a link 98. The configurations of the second mechanical linkage 95 and the second biasing member 99 are the same as those of the first mechanical linkage 90 and the first biasing member 94, and thus, keep both of the pass line lengths for the webs 30a and 30b same as each other.

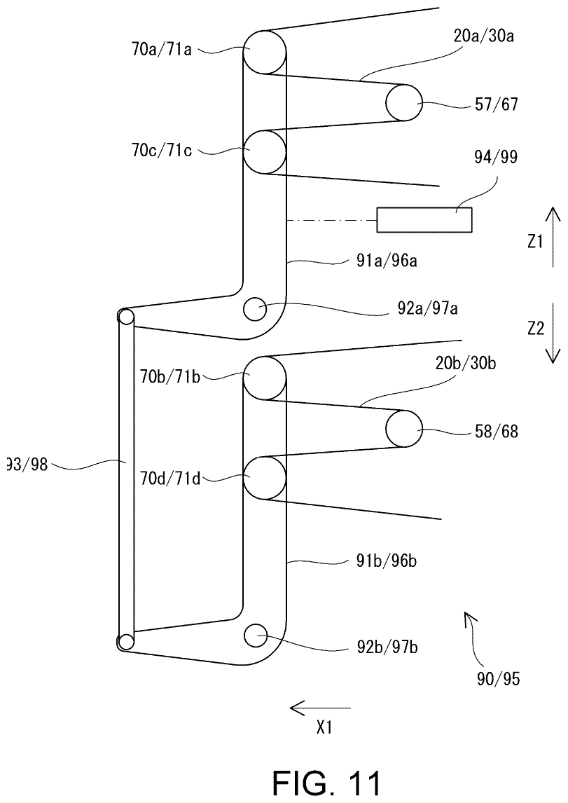

As illustrated in FIG. 11, an additional first dancer roller 70c and an additional second dancer roller 70d may be rotatably supported by the arms 91a and 91b of the first mechanical linkage 90, respectively. The webs 20a and 20b are engaged with the dancer rollers 70a and 70b, one of the stationary guide rollers 57 and 58 (the aforementioned guide rollers for guiding the webs 20a and 20b to the superposing roller pairs 40), and the additional dancer rollers 70c and 70d in this order, respectively. This reduces the swing amplitudes of the arms 91a and 91b.

Similarly, an additional third dancer roller 71c and an additional fourth dancer roller 71d may be rotatably supported by the arms 96a and 96b of the second mechanical linkage 95, respectively. The webs 30a and 30b are engaged with the dancer rollers 71a and 71b, one of the stationary guide rollers 67 and 68 (the aforementioned guide rollers for guiding the webs 30a and 30b to the superposing roller pair 40), and the additional dancer rollers 71c and 71d in this order, respectively. This reduces the swing amplitudes of the arms 96a and 96b.

In general, mono-material such as polyethylene, polypropylene has lower rigidity and higher stretchability than those of laminated material. For the use of the webs made of mono-material, their stretch lengths increase in proportion to the swing amplitudes of the dancer rollers. For the use of the webs 20a and 20b/30a and 30b made of mono-material, their stretchability can cause large fluctuations in the frictional force generated when the webs 20a and 20b/30a and 30b pass through the separation guides 54/64 (FIG. 6), resulting in the interference with smooth feed.

The configuration of FIG. 11 is capable of suppressing the swing amplitudes of the arms 91a and 91b/96a and 96b, and thus, the fluctuations in the frictional force described above, consequently providing smooth feed of the webs 20a and 20b/30a and 30b.

The configuration of FIG. 11 is also capable of suppressing the swing amplitudes of the arms 91a, 91b, 96a and 96b even if the intermittent feed pitch of the webs 20a to 30b is large downstream of the dancer rollers 70a to 71d. Consequently, this allows for suppressing the fluctuations in tensile stress applied to the web 20a to 30b, and thus, the stretch lengths of the webs 20a to 30b, providing smoother feed of the webs 20a to 30b.

The arms 91a, 91b, 96a and 96b preferably each have a small inertia and therefore are preferably made of lighter material such as carbon.

Other examples of the first and second guide mechanisms 5 and 6 that allow for the above bag making will be described below. The same reference numerals are used for the same or similar components.

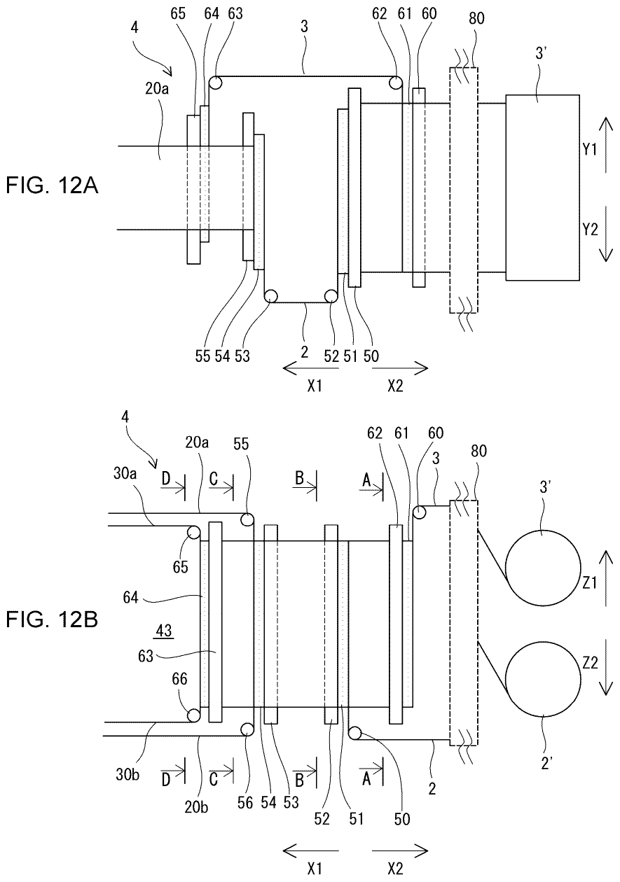

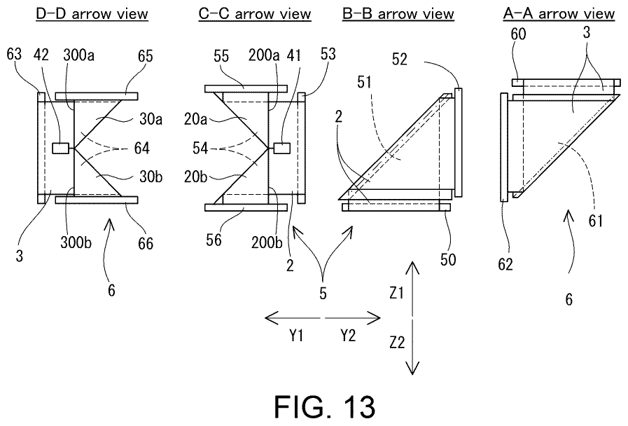

FIGS. 12A, 12B, and 13 illustrate an example superposing device 4. In this example, the midstream vertical rollers 690 and 691 (FIG. 7) of the previous example are not provided. The downstream vertical roller 63 is located on the Y1 side instead of the Y2 side. The upstream vertical roller 62 and the downstream vertical roller 63 serve as detour rollers for detouring the web 3 in the first lateral direction Y1 to prevent the interference of the web 3 with the slitter 41 and the components 50 to 56 of the first guide mechanism 5. The web 3 is redirected from the forward horizontal direction X1 to the second lateral direction Y2 by the downstream vertical roller 63 to pass through the slitter 42 (the D-D arrow view in FIG. 13). In this example, the edges 200a, 200b, 300a and 300b are not aligned with each other at the superposing roller pair 40.

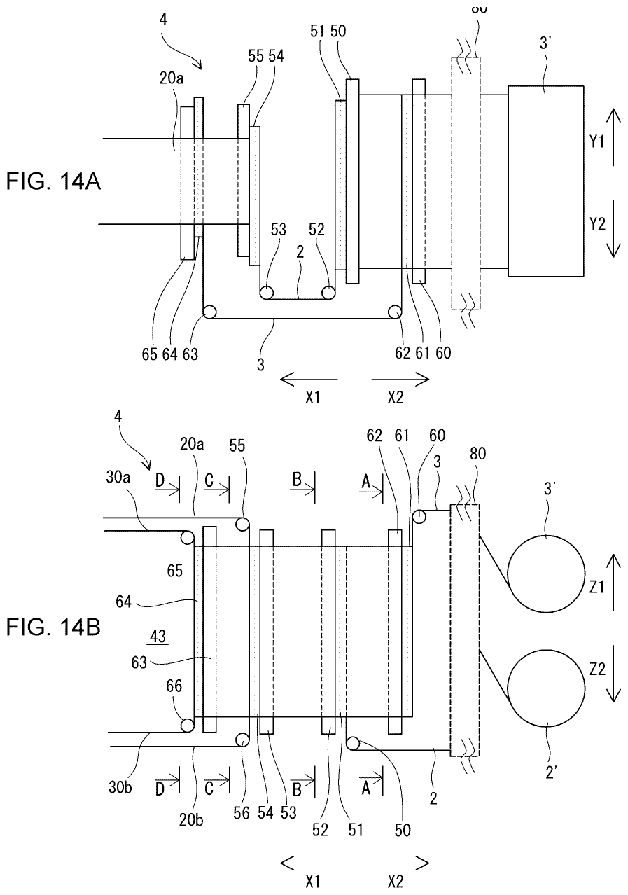

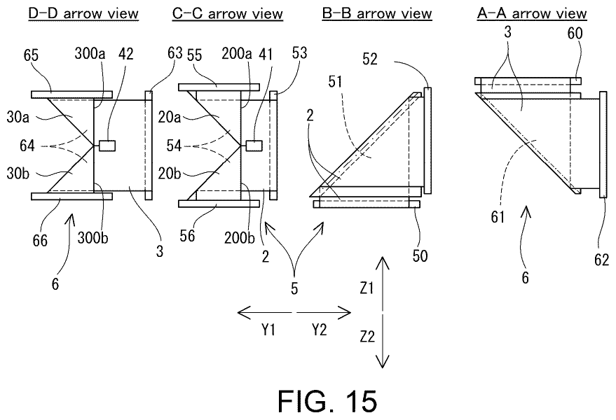

FIGS. 14A, 14B, and 15 illustrate a further example superposing device 4. As illustrated in the A-A arrow view in FIG. 15, the orientation of the inclined plate 61 in this example is opposite to that in the A-A arrow view in FIG. 6 so as to redirect the main web 3 in the second lateral direction Y2. Both the upstream vertical roller 62 and the downstream vertical roller 63 are positioned on the Y2 side instead of the Y1 side, thereby serving as detour rollers for detouring the web 3 further outward from the web 2 in the second lateral direction Y2 and then guiding the web 3 through the slitter 42 in order to prevent the interference of the web 3 with the slitter 41 and the components 50 to 56 of the first guide mechanism 5.

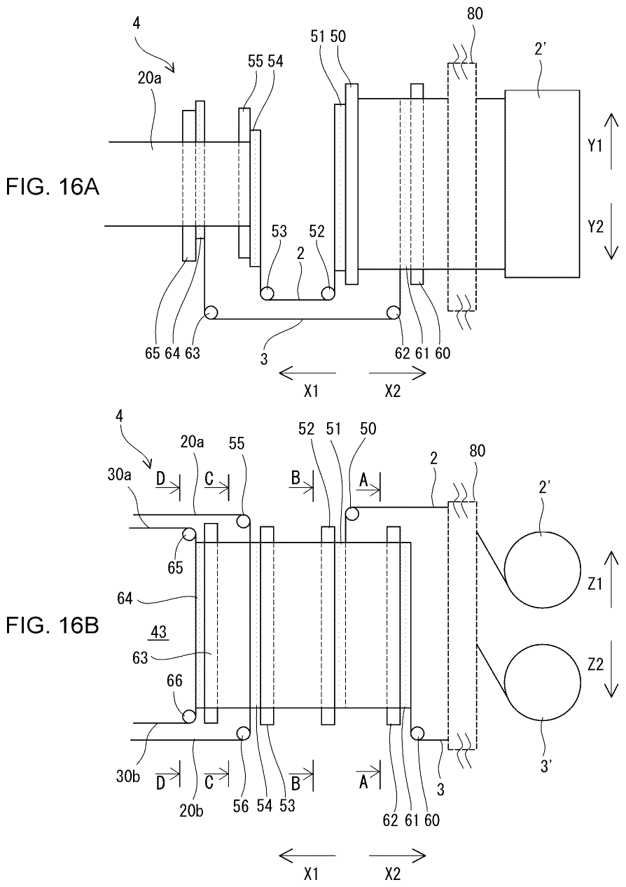

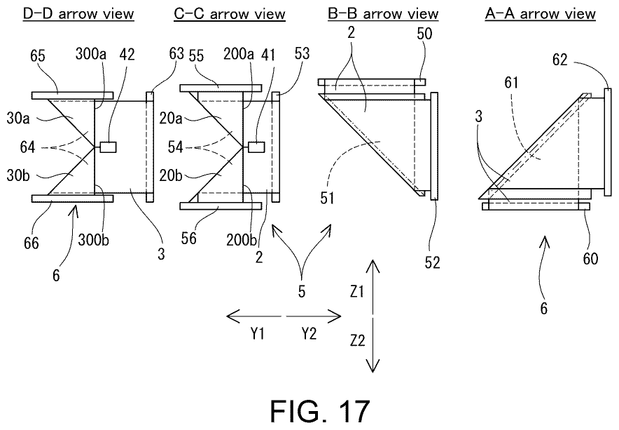

FIGS. 16A, 16B, and 17 illustrate a further example superposing device 4. As illustrated in FIGS. 16A and 16B, this example differs from the above examples in that the roll 2′ for the outer panels is arranged on the upper side and that the roll 3′ for the inner panels is arranged on the lower side. Furthermore, the roll 2′ is made by the main web 2 being wound such that the higher melting point surface layer is oriented inward. The web 2 is redirected from the forward horizontal direction X1 to the downward direction Z2 by the upstream horizontal roller 50, redirected to the second lateral direction Y2 by the inclined plate 51, and then redirected to the forward horizontal direction X1 by the upstream vertical roller 52 to be fed to the downstream vertical roller 53. This also allows the lower melting point surface layers of the webs 20a and 20b to contact the webs 30a and 30b, respectively, when the webs 20a to 30b are superposed on each other at the superposing roller pair 40, as in the other examples above.

The superposing device 4 can be applied not only to making of the simple double bags 1 of FIG. 1A, but also to making of any types of double bags. For example, it is obvious to those skilled in the art that the superposing device 4 may be incorporated into a bag making apparatus for making double bags with an additional auxiliary component(s) such as a zipper, a gusset, etc., instead of and/or in addition to the spout 15.

1. A web superposing device for use in a bag making apparatus configured to successively make double bags, the double bags each having a first outer panel, a second outer panel, a first inner panel, and a second inner panel, the first and second inner panels facing each other and being interposed between the first and second outer panels, the web superposing device comprising:
a first slitter for slitting a first main web into a first outer panel web for the first outer panel and a second outer panel web for the second outer panel as the first main web is fed from a first roll;
a second slitter for slitting a second main web into a first inner panel web for the first inner panel and a second inner panel web for the second inner panel as the second main web is fed from a second roll;
a superposing roller pair;
a first guide mechanism for guiding the first main web through the first slitter and guiding the first and second outer panel webs to the superposing roller pair, wherein the first guide mechanism is configured to keep the first and second outer panel webs separated from each other until the first and second outer panel webs reach the superposing roller pair to form a space between the first and second outer panel webs; and
a second guide mechanism for guiding the second main web through the second slitter and guiding the first and second inner panel webs from the space to the superposing roller pair to superpose the first outer panel web, the second outer panel web, the first inner panel web, and the second inner panel web on each other at the superposing roller pair.

2. The web superposing device of claim 1, wherein the superposing roller pair is spaced away from the first and second rolls in a forward horizontal direction,
wherein the first guide mechanism comprises:
a first separation guide for redirecting the first outer panel web from a lateral direction to an upward direction and the second outer panel web from the lateral direction to a downward direction, the lateral direction being perpendicular to the forward horizontal direction;
a first downstream horizontal roller disposed downstream of the first separation guide to redirect the first outer panel web from the upward direction to the forward horizontal direction; and
a second downstream horizontal roller disposed downstream of the first separation guide to redirect the second outer panel web from the downward direction to the forward horizontal direction; and
wherein the second guide mechanism comprises:
a second separation guide for redirecting the first inner panel web from the lateral direction to the upward direction and the second inner panel web from the lateral direction to the downward direction;
a third downstream horizontal roller disposed downstream of the second separation guide to redirect the first inner panel web from the upward direction to the forward horizontal direction; and
a fourth downstream horizontal roller disposed downstream of the second separation guide to redirect the second inner panel web from the downward direction to the forward horizontal direction.

3. The web superposing device of claim 2, wherein the second slitter and the second separation guide are spaced from the first separation guide in the forward horizontal direction and located below the first downstream horizontal roller and above the second downstream horizontal roller.

4. The web superposing device of claim 3, wherein the third and fourth downstream horizontal rollers are spaced from the first separation guide in the forward horizontal direction and are located below the first downstream horizontal roller and above the second downstream horizontal roller.

5. The web superposing device of claim 2, wherein the second guide mechanism further comprises detour rollers for detouring the second main web in the lateral direction from the first slitter and the first separation guide.

6. The web superposing device of claim 2, wherein the first guide mechanism further comprises a first downstream vertical roller for redirecting the first main web from the forward horizontal direction to the lateral direction to pass the first main web through the first slitter, and
wherein the first slitter is arranged to slit the first main web while the first main web is fed in the lateral direction subsequent to passing through the first downstream vertical roller.

7. The web superposing device of claim 6, wherein the second guide mechanism further comprises a second downstream vertical roller for redirecting the second main web from the forward horizontal direction to the lateral direction to pass the second main web through the second slitter, and
wherein the second slitter is arranged to slit the second main web while the second main is fed in the lateral direction subsequent to passing through the second downstream vertical roller.

8. The web superposing device of claim 1, wherein the first and second guide mechanisms are configured to guide the first and second outer panel webs and the first and second inner panel webs to orient edges of the first and second outer panel webs and the first and second inner webs in a same direction, said edges resulting from slitting.

9. A bag making apparatus for successively making double bags, comprising a web superposing device of claim 1.

10. The bag making apparatus of claim 9, further comprising:
a feeder disposed downstream of the superposing roller pair to intermittently feed the first and second outer panel webs and the first and second inner panel webs;
a first dancer roller for engaging with the first outer panel web at a position upstream of the superposing roller pair to switch the first outer panel web from continuous feed to intermittent feed;
a second dancer roller for engaging with the second outer panel web at a position upstream of the superposing roller pair to switch the second outer panel web from continuous feed to intermittent feed;
a first mechanical linkage for interlocking the first and second dancer rollers with each other; and
a first biasing member for applying the first and second dancer rollers towards the first and second outer panel webs, respectively, via the first mechanical linkage.

11. The bag making apparatus of claim 10, further comprising:
a third dancer roller for engaging with the first inner panel web at a position upstream of the superposing roller pair to switch the first inner panel web from continuous feed to intermittent feed;
a fourth dancer roller for engaging with the second inner panel web at a position upstream of the superposing roller pair to switch the second inner panel web from continuous feed to intermittent feed;
a second mechanical linkage for interlocking the third and fourth dancer rollers with each other; and
a second biasing member for applying the third and fourth dancer rollers towards the first and second inner panel webs, respectively, via the second mechanical linkage.

12. The bag making apparatus of claim 9, further comprising:
a feeder disposed downstream of the superposing roller pair to intermittently feed the first and second outer panel webs and the first and second inner panel webs;
a sealer disposed downstream of the superposing roller pair to heat-seal the first and second outer panel webs and the first and second inner panel webs; and
a cross cutter disposed downstream of the sealer to cross-cut the first and second outer panel webs and the first and second inner panel webs in a width direction of thereof during every intermittent feed cycle to make the double bags.
